(19) United States
(12) Patent Application Publication
(10) Pub. No.: US 2019/0080275 A1
(43) Pub. Date: Mar. 14, 2019

(54) PLATFORM FOR DELIVERY AND A METHOD THEREOF

(71) Applicants: Chad Brownell, Los Angeles, CA (US); Reynold Miguel, Torrance, CA (US)

(72) Inventors: Chad Brownell, Los Angeles, CA (US); Reynold Miguel, Torrance, CA (US)

(21) Appl. No.: 15/699,867

(22) Filed: Sep. 8, 2017

(51) Int. Cl. G06Q 10/08; G06Q 50/30; G06Q 50/00

(52) U.S. Cl. CPC G06Q 10/083; G06Q 50/01; G06Q 50/30

(57) ABSTRACT

The present disclosure relates to a platform that connects people on the go with people who have packages that need to go the same or similar direction, thereby making delivery of packages more efficient and reducing the need for people to travel just to deliver packages. The platform provides an open market where the sender of a package can provide an offer for the delivery of the package and any driver who is interested in delivering the package can accept the offer or provide a counteroffer. The platform may withhold credits from the sender and the driver's accounts to ensure that the sender has enough credit to deliver the package and the driver has enough credit to reimburse the sender if the package is lost or damaged.

### FIELD OF THE DISCLOSURE

The present disclosure generally relates to a platform for delivery and a method thereof. More specifically, the present disclosure provides a platform that connects people on the go with people who have packages that need to go the same way, eliminating or reducing the need for people (i.e., couriers) to travel just to deliver packages to increase the efficiency of delivery.

### BACKGROUND OF THE INVENTION

In the last decade, online shopping and delivery have grown exponentially. The money people spend online is projected to continue to increase within the next few years. Faster delivery, easier return policies, and cheaper price are some of the reasons that have increased the desirability of online shopping.

Conventionally, transportation of goods is handled by courier delivery service such as FedEx®, UPS® or post office. In most circumstances, a package that is to be delivered is either picked up by the delivery service or delivered to the delivery service by the sender, then the delivery service sends a driver to deliver the package to the recipient. In this process, the driver travels just for purpose of delivery and/or pick-up the package. Not only does this keep the cost of delivery high, it also increases air pollution as amount of delivery increases. For example, one of the main sources of air-quality pollutant is emissions from petrol, diesel, and alternative-fuel engines. In addition, sometimes packages will get lost, stolen or damaged during deliveries, and the responsibility often lies with the sender.

Accordingly, there exists a need for an improved delivery platform and method that allows packages to be delivered more efficiently and safely to their recipients. There also exists a need for an improved delivery platform and method that could reduce air pollution by eliminating or reducing the need for people to travel just to deliver and/or pick-up packages.

### SUMMARY OF THE INVENTION

One objective of the present disclosure is to provide a platform and a method that connect people on the go with people who have packages that need to go the same way, thereby making delivery of packages more efficient and convenient.

Another objective of the present disclosure is to provide a platform and a method that reduce air pollution created during deliveries by eliminating or reducing the need for people to travel just to deliver packages.

Another objective of the present disclosure is to provide a platform and a method that offer additional revenue for drivers to greatly offset their fuel cost and turn their commute into a net gain. Travelers can also earn money by transporting goods and saving others from the expense of travelling or shipping in the same direction they are travelling.

In accordance with one embodiment of the present disclosure, a platform is disclosed comprising a non-transitory computer-readable storage medium comprising programmable instructions adapted to be executed on one or more processors, and to perform a method of enabling drivers or travelers to deliver packages for senders at the platform server, the platform server being administered by at least one administrator, the programmable instructions causing at least one processor to: 1) receive a plurality of registrations from a plurality of users where each of the plurality of users is registered as sender or driver or both; 2) provide an option for a sender to request delivery of a package by asking the sender to input pick-up location and drop-off destination of the package; 3) provide a plurality of pre-defined options and fields for the sender to fill size of the package, description of the package, fee offered for delivering the package and optionally monetary value of the package; 4) share the pick-up location and drop-off destination of the package and the filled information about the package with a plurality of drivers based on at least one search criteria provided by the plurality of drivers or based on at least one default system setting; 5) receive counteroffers for delivering the package from the plurality of drivers and send the counteroffers to the sender; 6) check whether the sender has enough credit for delivering the package when the driver accepts the fee offered for delivering the package or when the sender accepts a counteroffer from the driver; 7) send a pick-up confirmation to the sender and the driver, and dispatch the driver or cause the driver to be dispatched to pick up and deliver the package; and 8) transfer the delivery fee or cause the delivery fee to be transferred from the sender's credit to the driver's credit when the packaged is successfully delivered within a specified time.

These and other features, aspects and advantages of the present invention will become better understood with reference to the following drawings, description and claims.

### BRIEF DESCRIPTION OF THE DRAWINGS

FIG. 1 is a flow chart showing the process of connecting a sender and a driver for delivery of a package according to an exemplary embodiment of the present disclosure.

FIG. 2 is a flow chart showing the shipping logic according to an exemplary embodiment of the present invention.

FIG. 3 is a flow chart showing the process of pick-up business purchase according to an exemplary embodiment of the present invention.

FIG. 4 is a flow chart showing the process of applying the disclosed platform on other services according to an exemplary embodiment of the present invention.

### DETAILED DESCRIPTION OF THE PREFERRED EMBODIMENT(S) AND INVENTION

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

For purpose of the present disclosure, the term “sender” or “shipper” generally refers to a person who sends out or requests a package to be delivered. However, the sender can also be the recipient. For instance, in some embodiments, the sender may ask a package to be picked up from a business or someone else, and have the package deliver to him/herself. The term “package”, “parcel”, “item” and “good” are also used interchangeably in the present discloser and are generally referring to the physical good that the sender wants to deliver or merchandise purchased from a store. They include, but are not limited to, commercial product, food, pet, livestock, grocery, money and valuables etc. The terms “driver”, “traveler” and “transporter” used herein generally refer to the person who delivers and/or picks up the package from the sender and delivers the package to its destination, and the terms may be used interchangeably within the present disclosure. Accordingly, the term “driver” is not limited to person who drives an automobile, the “driver” can also be a biker, a traveler or a walker etc.

Broadly, embodiments of the present disclosure generally relate to a platform and a method that connect or pair people on the go with people who have packages that need to go the same or similar direction, thereby making delivery of packages more efficient and reducing the need for people to travel just to deliver packages.

In one embodiment of the present disclosure, the disclosed platform comprises a non-transitory computer-readable storage medium comprising programmable instructions adapted to be executed on one or more processors, and to perform a method of enabling drivers or travelers to deliver packages for senders at the platform server, the platform server being administered by at least one administrator, the programmable instructions causing at least one processor to: receive a plurality of registrations from a plurality of users where each of the plurality of users is registered as sender or driver or both (if registering as driver, the driver may be prompted for his or her government ID such as driver's license); provide an option for a sender to request delivery of a package by asking the sender to input pick-up location and drop-off destination of the package; provide a plurality of pre-defined options and fields for the sender to fill size of the package, description of the package, fee offered for delivering the package and optionally monetary value of the package; share the pick-up location and drop-off destination of the package and the filled information about the package with a plurality of drivers based on at least one search criteria provided by the plurality of drivers or based on at least one default system setting; receive counteroffers for delivering the package from the plurality of drivers and send the counteroffers to the sender; check whether the sender has enough credit for delivering the package when the driver accepts the fee offered for delivering the package or when the sender accepts a counteroffer from the driver; send a pick-up confirmation to the sender and the driver, and dispatch the driver or cause the driver to be dispatched to pick up and deliver the package; and transfer the delivery fee or cause the delivery fee to be transferred from the sender's credit to the driver's credit when the packaged is successfully delivered within a specified time. The at least one administrator will have direct access to the web interface provided by the platform, either through a web browser or mobile application, and is able to provide moderation and customer service to platform users.

If the sender does not have an idea about how much should be offered for the delivery, the platform can provide a default or a recommended amount for the sender. The recommend amount may be based on what the current market dictates, a specific formula, the time the delivery is requested, the driver's tier (describe in detail below), the size of the package and/or the value of the package etc. For example, the formula for calculating the recommend amount can be (Base Amount)+(Distance miles)×(Cost per mile)×(Size). The platform may also apply surge to the recommended delivery amount if the sender requests the delivery during rush hour, at midnight, or under other urgent conditions, or if the package requires special care. If surge applies to a recommended delivery amount and the sender's offer is close to or same as the recommended delivery amount, the platform can be programmed to display the sender's offer in different colors to attract driver's attention (i.e., if the surge is 2×, the live post will be yellow and if the surge is 3×, the live post will be red etc.).

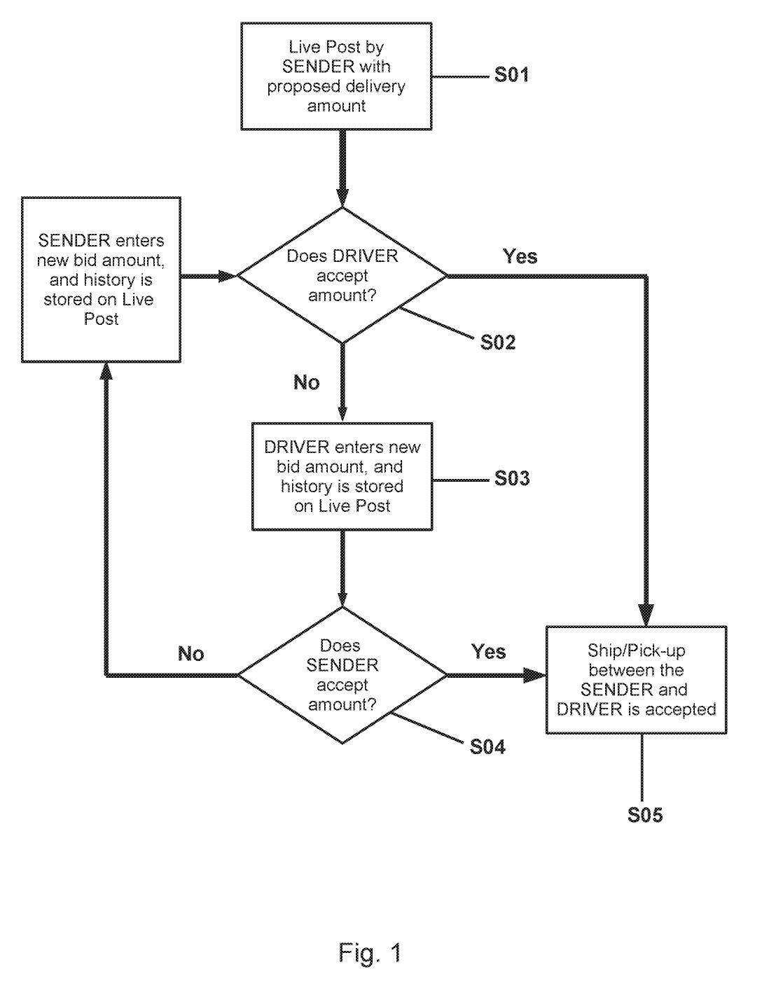

FIG. 1 is a flow chart showing the process of the disclosed platform connecting a sender with a driver for delivery of a package according to one exemplary embodiment of the present invention. First, as shown by S01, a sender creates a live post on the disclosed platform to request delivery of a package. The live post can be created via a mobile application running on a mobile device, or via a web browser running on any electronic device with internet connection. The request will include at least the pick-up location and drop-off destination of the package, description of the package (e.g., dimension, weight, type etc.), fee offered by sender for delivering the package, and optionally monetary value of the package and/or picture of the package if available. The sender may input the pick-up location and drop-off destination via a map interface provided by the disclosed platform or by a mobile application associated with the disclosed platform by pin drop the pick-up location and/or drop-off destination on the map. If the sender is delivering the package from his or her location, the sender may have his or her location detected using the mobile device's GPS. If GPS is unavailable or if the sender is requesting the package to be picked up at a remote location (i.e., a store or friend's house), the sender can manually input the address or the store name.

The delivery request will then be shared with a plurality of drivers based on their preference, setting or search criteria on the platform. If a driver does not specify any preference, setting or search criteria, a default system setting may apply (e.g., based on distance between the driver and the pick-up location etc.). Driver's preference, setting or search criteria may include, but is not limited to, location of the driver, destination of the driver, amount of delivery fee (i.e., a specified range) offered by the sender, monetary value of the package, a map polygon (or a specified area, city or county etc.) defined by the driver showing their desired pick up and/or drop off area, or combination thereof

After the delivery request is shared with the plurality of drivers, any driver who has access to the delivery request can accept the delivery request if he or she is satisfied with the delivery fee offered by the sender as shown in S02. If the sender's delivery request is accepted by a driver, the delivery request will no longer be available to other drivers, and the delivery of package is established between the sender and the driver as shown in S05. However, if a driver is not satisfied with the delivery fee offered by the sender and the delivery request has not been accepted by anyone, the driver may provide a counteroffer (i.e., a bid amount) to the sender as shown in S03. If the sender accepts the counteroffer as shown in S04, the delivery of package is established between the sender and the driver as shown in S05 as well. If the sender does not accept the counteroffer, the sender can either declined it, or provide a different offer (e.g., counteroffer to driver's counteroffer), and the process can go on until one party either accepts the offer/counteroffer or gives up. All the bidding history can be saved on the platform server and available to users. In addition, the sender may view the driver's profile and check the driver's rating and/or delivery history to determine whether to accept or decline the counteroffer after receiving it from the driver.

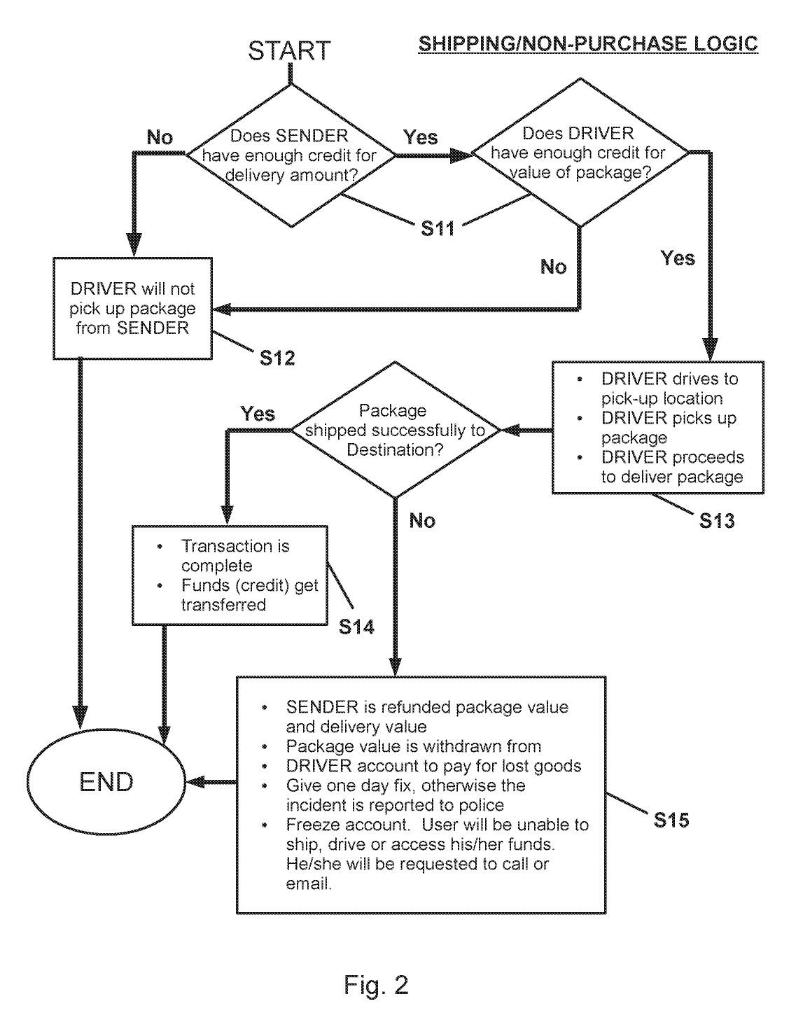

FIG. 2 is a flow chart showing the shipping logic after the delivery of package is established between the sender and the driver according to another exemplary embodiment of the present invention. After the driver accepts the fee offered for delivering the package or the sender accepts the counteroffer from the driver, the platform checks whether the sender has enough credit in his or her account at the platform server or at a third party financial institute or payment gateway (i.e., Visa®, PayPal® etc.) for delivering the package and optionally whether the driver has enough credit in his or her account at the platform server or at a third party financial institute or payment gateway to cover the monetary value of the package as shown by S11, assuming the monetary value of the package has been provided by the sender or based on system defaults. If the sender or the driver (or both) does not have enough credit, the delivery of package (i.e., the transaction) is cancelled and the driver will not be instructed to pick up the package from the sender as shown by S12. The shipper and driver can also communicate with each other through a direct messaging system of the platform.

If both the sender and the driver have enough credit, the driver will be instructed or notified (e.g., through pop-up message, push notification, text message, call, email etc.) by the platform to proceed with picking up and delivering the package as shown by S13. After the package is delivered successfully, the transaction for delivery is complete between the sender and the driver, and the delivery fee is transferred from sender's account to the driver's account as shown by S14. Alternatively, the platform may withhold the delivery fee from sender's account in advance, and transfer the delivery fee from the withheld fund to the driver once the delivery is complete. If there is an excess withheld fund after the transaction is complete, the excess fund will be returned to or unwithheld from the sender.

The driver may be requested to provide pick up and/or drop off confirmations and details after the driver picks up and/or delivers the package so that the sender knows the process of the delivery. For example, in one embodiment, once the driver picks up the package, the driver will notify the sender through the platform (e.g., by clicking a receive button on the mobile application provided). The sender may also be requested to approve the delivery (e.g., by clicking a shipped button on the mobile application provided). After the delivery is approved, the sender will be able to track the driver's path. Once the package is delivered, a notification will be sent to the sender, and the driver may be required to take a picture to show proof of delivery (e.g., picture of package at destination). Then the sender can confirm the delivery through various means (e.g., phone call, text, or email) and the transaction is deemed complete. The sender may also confirm and release the package any time after the driver has picked up the package, this option will allow the sender to pre-confirm if the sender wanted to, so the sender does not need to wait around to confirm drop-off. An invoice will be generated and delivered to the sender after the transaction is complete, and the sender will be given an option to rate the driver and provide his or her comments. Optionally, the disclosed platform may also allow the driver to rate the sender. All the shipping/delivery history (e.g., history of delivered items) will be saved on the platform server and available to the sender and respective drivers.

On the other hand, if the package is not delivered to the destination within a specified time or is lost during the delivery, the sender will be reimbursed with the monetary value of the package and the delivery fee (if it has been withheld by the platform or paid to the driver). The monetary value of the package will be withdrawn from the driver's account as shown by S15. In one embodiment, if the driver fails to deliver the package or if the package is damaged, the platform may give the driver a specified time to redeliver or to resolve the issue. If the driver does not redeliver or resolve the issue within the given time, the driver will be penalized. Penalty may include, but not limited to, reporting the incident to police (i.e., if the package is stolen by the driver) and freezing the driver's account. User with frozen account will be unable to ship, drive or access his or her account and funds. The user will be requested to call or email the administrator to unfreeze his or her account and to resolve the issue. The disclosed platform can also be programmed to track the driver's delivery progress and automatically deduct the package's monetary value from the driver's credit when the driver fails to deliver the package within a specified time, and reimburse the sender or cause the sender to be reimbursed with the package's monetary value and delivery fee. Also, the sender may track and monitor the delivery process of the driver in real time through GPS, and the driver will be accessible to the sender throughout the process as well.

In yet another embodiment of the present disclosure, the platform will classify each of the plurality of users who registers as driver into different tiers and the sender can specify which tier or tiers of driver can deliver the package. The tiers may be classified based on at least one of criteria comprising driver's driving experience, moving or delivery experience, driving or delivery history, available professional driving or moving license, credit history and criminal history etc. For example, a driver with professional moving license and experience without any criminal record or complaint will be classified in a higher tier, while a driver without much experience or with criminal history will be classified in a lower tier. The sender will be able to designate that only drivers with certain tier or above can accept his or her request for delivery.

In yet another embodiment of the present disclosure, a driver can input his or her traveling path or starting location and destination of a trip into the system platform, and the system platform will notify the driver whenever a sender's pick-up location and drop-off destination of the package is similar to or match the traveling path or starting location and destination of the trip of the driver by a specified percentage or distance, or within a specified geographic area.

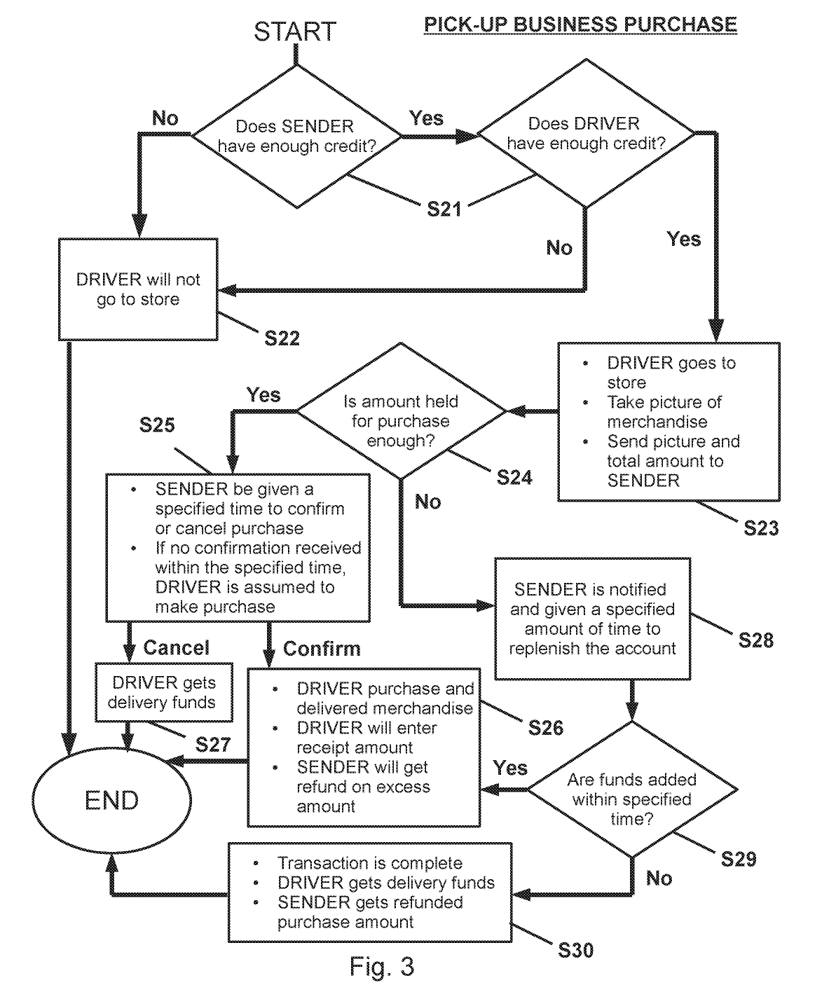

FIG. 3 is a flow chart showing the process of pick-up business purchase according to another exemplary embodiment of the present invention. In this embodiment, the sender is requesting a driver to go to a store (or business) to pick up and delivery a package, where the sender may himself or herself be the recipient. If the sender has already paid the store for the price of the package, then the process of pick-up and delivery of the package and fund transfer is identical to the processes described in FIGS. 1 and 2. For instance, before the driver is instructed to go to the store to pick up the package, the platform will check whether the sender has enough credit in his or her account at the platform server or at a third party financial institute or payment gateway for delivery and whether the driver has enough credit in his or her account at the platform server or at a third party financial institute or payment gateway for monetary value of the package. If the delivery is complete and successful, the delivery fee is transferred from the sender's account to the driver's account. However, if the driver fails to deliver the package within a specified time or if the package is lost, the monetary value of the package is deducted from the driver's account and reimbursed to the sender's account. Note that the package is not limited to a single item, it can contain multiple items and up to a specified amount, size and/or weight (e.g., max of 20 items, 100 pounds etc.).

On the other hand, if the sender is requesting the driver to purchase the package from the store with the driver's own money before delivering the package, the disclosed platform will implement additional steps to protect the driver. In the embodiment described by FIG. 3, the disclosed platform comprises a non-transitory computer-readable storage medium comprising programmable instructions adapted to be executed on one or more processors, and to perform a method of enabling drivers or travelers to purchase and deliver packages from stores for senders at a platform server, the platform server being administered by at least one administrator, the programmable instructions causing at least one processor to: receive a plurality of registrations from a plurality of users where each of the plurality of users is registered as sender or driver or both; provide an option for a sender to request purchase and delivery of a package from a store by asking the sender to input the store's name or location and drop-off destination of the package; provide a plurality of pre-defined options and fields for the sender to fill description of the package, fee offered for delivering the package, and optionally monetary value of the package and picture of the package; share the store's name or location and drop-off destination of the package and the filled information about the package with a plurality of drivers based on at least one search criteria provided by the plurality of drivers or based on at least one default system setting; receive counteroffers for delivering the package from the plurality of drivers and send the counteroffers to the sender; check whether the sender has enough credit for delivering the package when the driver accepts the fee offered for delivering the package or when the sender accepts a counteroffer from the driver; send purchase and delivery confirmations to the sender and the driver, and dispatch the driver or cause the driver to be dispatched to go to the store after verifying that the sender has enough credit for delivering the package; receive the package's total purchase value from the driver and verify whether the sender has enough credit for the package's total purchase value; notify the sender when the sender does not have enough credit for the package's total purchase value and give the sender a specified time to replenish the sender's credit, and transfer the delivery fee or cause the delivery fee to be transferred from the sender's credit to the driver's credit if the sender does not replenish the sender's credit within the specified time; authorize the driver to purchase the package when the sender has enough credit for the package's total purchase value and withhold the package's total purchase value from the sender's credit; and track the driver's delivery progress and transfer the delivery fee from the sender's credit to the driver's credit when the packaged is successfully delivered within a specified time.

As shown by S21 of FIG. 3, after the driver accepts the fee offered for delivering the package or after the sender accepts a counteroffer from the driver, the disclosed platform checks whether the sender has enough credit for delivering the package. If the sender does not have enough credit, the deriver will not be dispatched and the delivery transaction ends as shown by S22. If the sender has enough credit for delivering the package, then the platform dispatches the driver or cause the driver to be dispatched to the store as shown by S23. After the driver arrives the store, the driver is required to take picture of the package (i.e., the merchandise), verify the total purchase price of the package, and provide the picture and total purchase price to the sender through the disclosed platform (i.e., the price may be provided as pictures or text). As shown by S24 and S25, if the sender has enough credit in his or her account to cover the total purchase price of the package, the sender will be given a specified time (e.g., five minutes) to confirm or cancel the purchase. The disclosed system can be programmed in a way that if the no confirmation or cancellation is received from the sender within the specified time, the purchase is confirmed by default. As shown by S26, after the sender confirms the purchase, the driver will be instructed to make the purchase (with the driver's own money or account) and deliver the package. The platform may withhold the total purchase price from the sender's account or the sender may also enter an amount to be withheld (e.g., up to $50, up to $100 or others etc.) before the driver makes the purchase to ensure that the sender has sufficient fund to reimburse the driver. If the sender changes his or her mind and decides to cancel the purchase, the driver will get the delivery fund and the transaction ends as shown by S27.

Once the package is delivered to its recipient (i.e., to the drop off destination) successfully, the delivery fee and the total purchase price is transferred from the sender's account to the driver's account. If there is an excess withheld fund after the transaction is complete, the excess fund will be returned to or unwithheld from the sender. However, if the sender does not have sufficient fund in his or her account to cover the total purchase price of the package in S24, the platform will send a notification to the sender requesting the sender to replenish his or her credit (or account) within a given time (e.g., 5 minutes) as shown by S28. As shown by S29, if the sender's credit is replenished within the given time, then the driver is instructed to make the purchase and deliver the package as previously described in S26, and the delivery fee and the total purchase price is transferred from the sender's account to the driver's account after the delivery completes. However, in the event that the sender fails to replenish the credit within the given time or if the sender changes his or her mind about purchasing the item, then the platform will transfer the delivery fee from the sender's account to the driver's account, and the transaction completes as shown by S30. Similarly, any excess withheld fund will be returned to or unwithheld from the sender after the transaction completes.

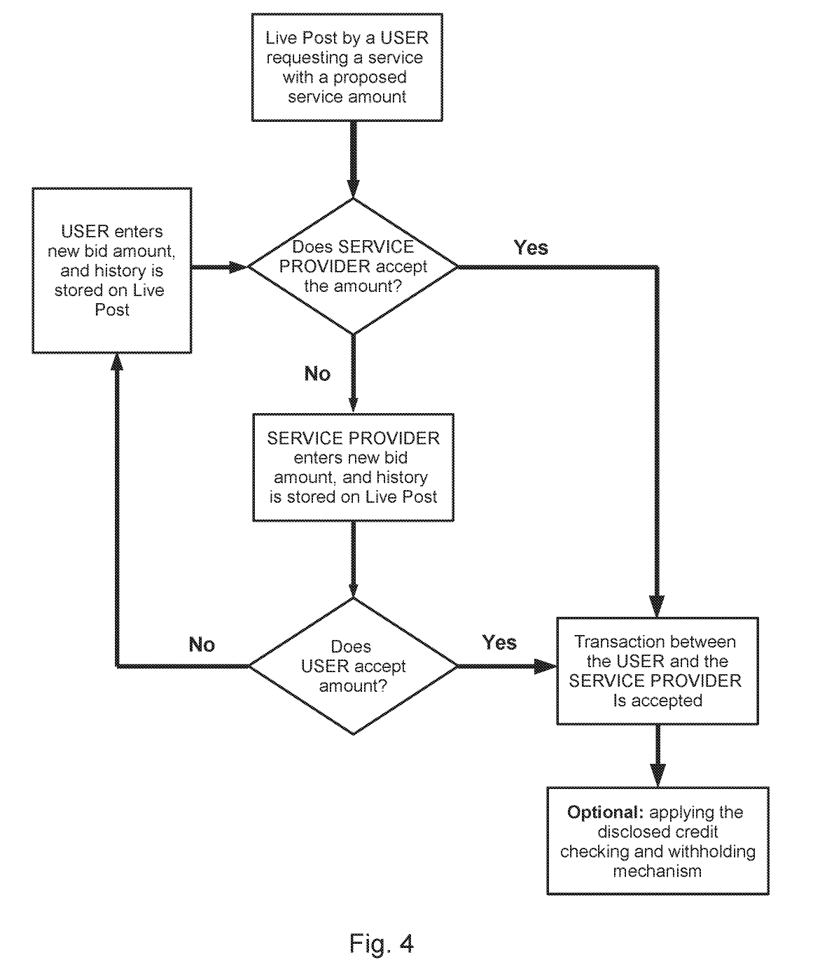

It should be noted that the disclosed platform is not limited to delivery services, it can also apply to other area of services such as housekeeping, gardening, plumbing, legal, landscaping and therapist services etc. FIG. 4 is an exemplary flow chart showing the application of the disclosed platform on other services, where a user requesting a service is connected to a service provider through similar means as described above. First, a user creates a live post on the disclosed platform to request for a service he or she needs. The live post can be created via a mobile application running on a mobile device, or via a web browser running on any electronic device with internet connection. The service request will include at least the description of the service required and the fee offered by the user for the service. The user may input the location requiring the service via a map interface provided by the disclosed platform or by a mobile application associated with the disclosed platform by pin drop the location on the map. If the user is requesting the service from his or her location, the user may have his or her location detected using the mobile device's GPS. The user can also manually input the address.

The service request will then be shared with a plurality of service providers based on their preference, setting or search criteria on the platform. Service provider's preference, setting or search criteria may include, but is not limited to, type of service, service requesting location, experience required and amount of service fee (e.g., a range) offered by the user etc. After the service request is shared with the plurality of service providers, any service provider who has access to the service request can accept the service request if he or she is satisfied with the service fee offered by the user. If the user's service request is accepted by a service provider, the service request will no longer be available to other service providers, and the transaction between the user and the service provider is established. However, if a service provider is not satisfied with the service fee offered by the user and the service request has not been accepted by anyone, the service provider may provide a counteroffer (i.e., a bid amount) to the user. If the user accepts the counteroffer, the transaction is established between the user and the service provider as well. If the user does not accept the counteroffer, the user can either declined it, or provide a different offer (e.g., counteroffer to service provider's counteroffer), and the process can go on until one party either accepts the offer/counteroffer or gives up. All the bidding history can be saved on the platform server and available to users. In addition, the user may view the service provider's profile and check the service provider's rating and/or service history to determine whether to accept or decline the counteroffer after receiving it from the service provider.

After the transaction is established between the user and the service provider, the payment/credit withholding mechanism described previously in FIG. 2 and FIG. 3 can apply here as well. For example, the platform can be programmed in a way that once a transaction is established, it will verify whether the user has enough credit in his or her account to pay for the service. If there is insufficient credit, the user will be notified and be given a specified time to replenish the credit. If the user fails to replenish the credit, the transaction is then cancelled. If there is sufficient credit, the platform may put a hold on the credit, and transfer the service fee from the user's account to the service provider's account after the requested service is completed. Depending on the services requested, the platform may also withhold certain amount of money from service provider's account to protect the user, and to prevent service provider from performing the service recklessly (e.g., damaging things during the service).

It should also be noted that when the term “a”, “an”, etc. is used, it is to be interpreted as “at least one” throughout the application, drawings, and claims.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A non-transitory computer-readable storage medium comprising programmable instructions adapted to be executed on one or more processors, and to perform a method of enabling drivers or travelers to deliver packages for senders at a platform server, the platform server being administered by at least one administrator, the programmable instructions causing at least one processor to:
receive a plurality of registrations from a plurality of users where each of the plurality of users is registered as sender or driver or both;
provide an option for a sender to request delivery of a package by asking the sender to input pick-up location and drop-off destination of the package;
provide a plurality of pre-defined options and fields for the sender to fill size of the package, description of the package, fee offered for delivering the package and optionally monetary value of the package;
share the pick-up location and drop-off destination of the package and the filled information about the package with a plurality of drivers based on at least one search criteria provided by the plurality of drivers or based on at least one default system setting;
receive counteroffers for delivering the package from the plurality of drivers and send the counteroffers to the sender;
check whether the sender has enough credit for delivering the package when the driver accepts the fee offered for delivering the package or when the sender accepts a counteroffer from the driver;
send a pick-up confirmation to the sender and the driver, and dispatch the driver or cause the driver to be dispatched to pick up and deliver the package; and
transfer the delivery fee or cause the delivery fee to be transferred from the sender's credit to the driver's credit when the packaged is successfully delivered within a specified time.

2. The computer-readable medium of claim 1, wherein the option for the sender to input pick-up location and drop-off destination is a map interface that displays sender's location and allow the sender to pin drop his or her location on the map interface or input the pick-up location or drop-off destination or both via text.

3. The computer-readable medium of claim 1, wherein the pick-up location and drop-off destination of the package and the filled information about the package are shared by the system platform via a live post.

4. The computer-readable medium of claim 1, wherein the at least one search criteria provided by the plurality of drivers is location of the plurality of drivers, destination of the plurality of drivers, amount of delivery offered by the sender, a map polygon defined by the plurality of drivers showing their desired delivery area, or combination thereof.

5. The computer-readable medium of claim 1, wherein the instructions further comprise the step of causing at least one processor to classify each of the plurality of users who registers as driver into different tiers and the sender can specify which tier or tiers of driver can deliver the package.

6. The computer-readable medium of claim 5, wherein the tiers are classified based on at least one of criteria comprising driver's driving experience, moving or delivery experience, driving or delivery history, available professional driving or moving license, credit history, and criminal history.

7. The computer-readable medium of claim 1, wherein the instructions further comprise the step of causing at least one processor to receive a traveling path or starting location and destination of a trip from a driver, and notify the driver when the sender's pick-up location and drop-off destination of the package is similar to or match the traveling path or starting location and destination of the trip of the driver by a specified percentage or distance.

8. The computer-readable medium of claim 1, wherein the instructions further comprise the step of causing at least one processor to verify whether the sender has enough credit for delivering the package and notify the sender when there is insufficient credit, the pick-up location and drop-off destination of the package and the filled information about the package will not be shared with a plurality of drivers if the credit is insufficient

9. The computer-readable medium of claim 1, wherein the instructions further comprise the step of causing at least one processor to track the driver's delivery progress and deduct the package's monetary value from the driver's credit when the driver fails to deliver the package within a specified time, and reimburse the sender or cause the sender to be reimbursed with the package's monetary value and delivery fee.

10. A non-transitory computer-readable storage medium comprising programmable instructions adapted to be executed on one or more processors, and to perform a method of enabling drivers or travelers to deliver packages for senders at a platform server, the platform server being administered by at least one administrator, the programmable instructions causing at least one processor to:
receive a plurality of registrations from a plurality of users where each of the plurality of users is registered as sender or driver or both;
provide an option for a sender to request delivery of a package by asking the sender to input pick-up location and drop-off destination of the package, where the sender input pick-up location and drop-off destination via a map interface that displays sender's location and allow the sender to pin drop his or her location on the map interface or input the pick-up location or drop-off destination or both via text;
provide a plurality of pre-defined options and fields for the sender to fill size of the package, description of the package, fee offered for delivering the package and monetary value of the package;
share via live post the pick-up location and drop-off destination of the package and the filled information about the package with a plurality of drivers based on at least one search criteria provided by the plurality of drivers or based on at least one default system setting;
receive counteroffers for delivering the package from the plurality of drivers and send the counteroffers to the sender;
check whether the sender has enough credit for delivering the package and whether the driver has enough credit for the monetary value of the package when the driver accepts the fee offered for delivering the package or when the sender accepts a counteroffer from the driver;
notify the sender when there is insufficient credit for delivering the package and notify the driver when there is insufficient credit for covering the monetary value of the package;
send pick-up confirmations to the sender and the driver, and dispatch the driver or cause the driver to be dispatched to pick up and deliver the package from the sender when the sender has sufficient credit for delivering the package and the driver has sufficient credit for the monetary value of the package;
track the driver's delivery progress and deduct the monetary value of the package from the driver's credit when the driver fails to deliver the package within a specified time, and reimburse the sender or cause the sender to be reimbursed with the monetary value of the package and deliver fee; and
transfer the delivery fee from the sender's credit to the driver's credit when the packaged is successfully delivered within a specified time.

11. The computer-readable medium of claim 10, wherein the at least one search criteria provided by the plurality of drivers is location of the plurality of drivers, destination of the plurality of drivers, amount of delivery offered by the sender, a map polygon defined by the plurality of drivers showing their desired delivery area, or combination thereof.

12. The computer-readable medium of claim 10, wherein the instructions further comprise the step of causing at least one processor to classify each of the plurality of users who register as driver into different tiers and the sender can specify which tier or tiers of driver can deliver the package.

13. The computer-readable medium of claim 12, wherein the tiers are classified based on at least one of plurality criteria comprising driver's driving experience, moving or delivery experience, driving or delivery history, available professional driving or moving license, credit history, and criminal history.

14. The computer-readable medium of claim 10, wherein the instructions further comprise the step of causing at least one processor to receive a traveling path or starting location and destination of a trip from a driver, and notify the driver when the sender's pick-up location and drop-off destination of the package is similar to or match the traveling path or starting location and destination of the trip of the driver by a specified percentage or distance.

15. A non-transitory computer-readable storage medium comprising programmable instructions adapted to be executed on one or more processors, and to perform a method of enabling drivers or travelers to purchase and deliver packages from stores for senders at a platform server, the platform server being administered by at least one administrator, the programmable instructions causing at least one processor to:
receive a plurality of registrations from a plurality of users where each of the plurality of users is registered as sender or driver or both;
provide an option for a sender to request purchase and delivery of a package from a store by asking the sender to input the store's name or location and drop-off destination of the package;
provide a plurality of pre-defined options and fields for the sender to fill description of the package, fee offered for delivering the package and optionally monetary value of the package;
share the store's name or location and drop-off destination of the package and the filled information about the package with a plurality of drivers based on at least one search criteria provided by the plurality of drivers or based on at least one default system setting;
receive counteroffers for delivering the package from the plurality of drivers and send the counteroffers to the sender;
check whether the sender has enough credit for delivering the package when the driver accepts the fee offered for delivering the package or when the sender accepts a counteroffer from the driver;
send purchase and delivery confirmations to the sender and the driver, and dispatch the driver or cause the driver to be dispatched to go to the store after verifying that the sender has enough credit for delivering the package;
receive the package's total purchase value from the driver and verify whether the sender has enough credit for the package's total purchase value;
notify the sender when the sender does not have enough credit for the package's total purchase value and give the sender a specified time to replenish the sender's credit, and transfer the delivery fee or cause the delivery fee to be transferred from the sender's credit to the driver's credit if the sender does not replenish the sender's credit within the specified time;
authorize the driver to purchase the package when the sender has enough credit for the package's total purchase value and withhold the package's total purchase value from the sender's credit; and
track the driver's delivery progress and transfer the delivery fee from the sender's credit to the driver's credit when the packaged is successfully delivered within a specified time.

16. The computer-readable medium of claim 15, wherein the at least one search criteria provided by the plurality of drivers is location of the plurality of drivers, destination of the plurality of drivers, amount of delivery offered by the sender, a map polygon defined by the plurality of drivers showing their desired delivery area, or combination thereof.

17. The computer-readable medium of claim 15, wherein the instructions further comprise the step of causing at least one processor to classify each of the plurality of users who register as driver into different tiers and the sender can specify which tier or tiers of driver can ship the sender's package.

18. The computer-readable medium of claim 17, wherein the tiers are classified based on at least one of plurality criteria comprising driver's driving experience, moving or delivery experience, driving or delivery history, available professional driving or moving license, credit history, and criminal history.

19. The computer-readable medium of claim 15, wherein the instructions further comprise the step of causing at least one processor to receive a traveling path or starting location and destination of a trip from a driver, and notify the driver when the store's location and drop-off destination of the package is similar to or match the traveling path or starting location and destination of the trip of the driver by a specified percentage or distance.

20. The computer-readable medium of claim 15, wherein the instructions further comprise the step of causing at least one processor to refund the sender or cause the sender to be refunded for any excess amount that is withhold from the sender's credit.
